(19) United States
(12) Patent Application Publication
(10) Pub. No.: US 2012/0118402 A1
(43) Pub. Date: May 17, 2012

(54) GAS CYLINDER VALVE

(76) Inventor: David William Birch, Hampshire (GB)

(21) Appl. No.: 13/320,659

(22) PCT Filed: May 11, 2010
(86) PCT No.: PCT/GB2010/000936

§ 371 Date: Dec. 1, 2011

(30) Foreign Application Priority Data
May 19, 2009 (GB) 0908602.6

(51) Int. Cl. F16K 1/30

(52) U.S. Cl. 137/237

(57) ABSTRACT

A gas cylinder valve has a permanent coating of a solid lubricant on at least one of its internal frictional surfaces. The solid lubricant consists of or comprises tungsten disulfide. For example, the frictional surfaces of the upper spindle 10 and lower spindle 12 are provided with such a permanent coating. So are the surfaces that rub against the lower spindle 12 and upper spindle 10 when these are translated by turning the handwheel 8 of the gas cylinder valve.

This invention relates to a gas cylinder valve.

A gas cylinder is a container of compressed gas. The container is conventionally of cylindrical shape, but need not be. The term ‘gas cylinder’ is applied herein to containers of compressed gas irrespective of whether the container has a cylindrical shape or not.

A gas cylinder valve is a valve fitted in the mouth of a gas cylinder which fulfils the functions of acting as a closure for the gas cylinder so that gas can be successfully stored therein under pressure, sometimes up to 300 bar or higher, of enabling gas to be withdrawn from the gas cylinder by a user, and of enabling the cylinder to be refilled with gas.

Gas cylinders and gas cylinder valves have been known and widely used for more than one hundred years.

A gas cylinder valve includes one or more rotary spindles which fit within the main body of the valve. It is traditional to grease such functional parts so as to provide lubrication and make the valve easier to operate and to prolong its working life. For at least the last 25 years fluorinated greases and fluorinated oils have been used. Several problems are associated with the use of such lubricants.

The lubricants tend to dry out over time and lose their effectiveness. There is difficulty in applying the correct amount. The lubricants have a certain toxicity and are therefore not ideal for medical and breathing use. The lubricants tend to attract or trap, and then to retain, solid debris, which increases their vulnerability to ignition when the valve is opened. Further, the retention of debris can cause problems when a highly pure gas is required, as is often the case in the electronics industry.

According to the present invention there is provided a gas cylinder valve having a permanent coating of a solid lubricant on at least one of its internal frictional surfaces.

The solid lubricant consists of or comprises tungsten disulfide. If desired, molybdenum disulfide be used in addition to tungsten disulfide.

The coating of solid lubricant preferably has a uniform thickness, preferably, of up to 5 microns, and more preferably in the range of 0.5 to 1 micron.

The gas cylinder valve may incorporate a residual pressure valve, a pressure regulating valve or a flow control valve, or it may be of a traditional kind incorporating none of these additional valves.

All these kinds of gas cylinder valve have a spindle which is able to be rotated within a bore or counterbore in the body of the valve. Turning of the spindle, for example by means of a hand wheel is able to displace the main valve member of this valve. Preferably the frictional surface of the spindle and the complementary frictional surfaces of the body and a gland rut through which the spindle extends have a permanent coating of solid lubricant.

In some gas cylinder valves there is a two-part spindle comprising an inner (or lower) and an outer (or upper) part. The frictional surfaces of both parts preferably have a coating of the solid lubricant.

In gas cylinder valves with a residual pressure valve, preferably the mutually engaging surfaces of the shuttle and the back nut of the residual pressure valve both have a coating of the solid lubricant.

The coating may be deposited on the chosen parts of a gas cylinder valve by any suitable coating method, for example by high velocity impingement typically at ambient temperature of tungsten disulfide particles, typically of 1-5 micron particle size, on the chosen parts.

A gas cylinder valve according to the invention will now be described by way of example with reference to the accompanying drawings , in which:

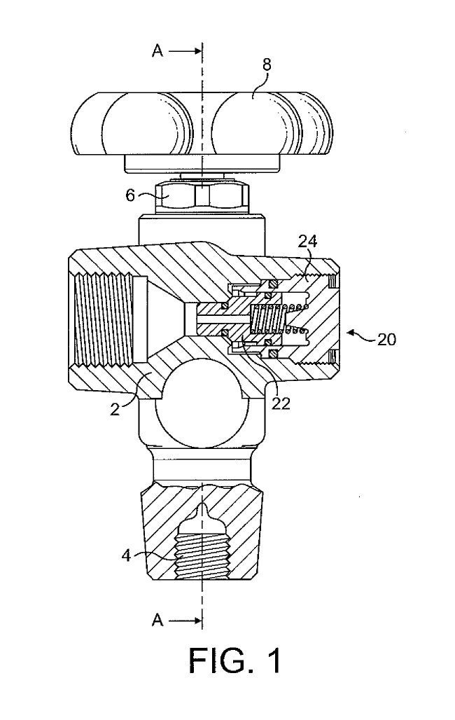

FIG. 1 is a sectional side elevation of a gas cylinder valve of a kind that includes a residual pressure valve;

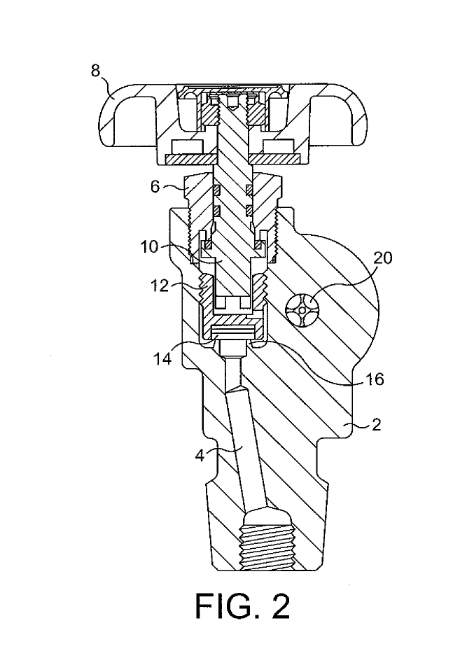

FIG. 2 is a cross-section through the line A-A of FIG. 1; and

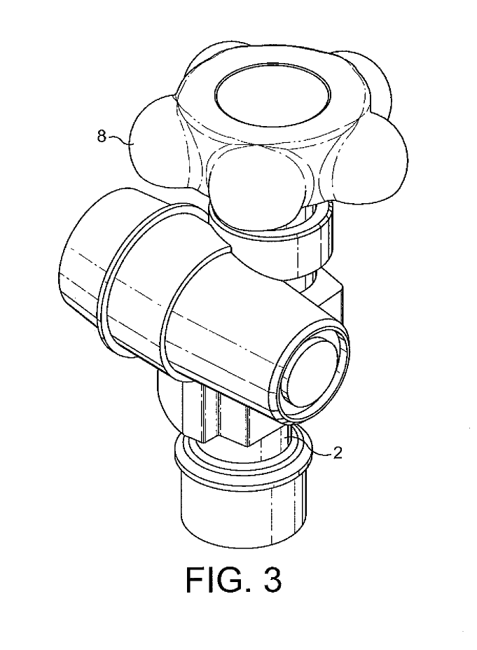

FIG. 3 is a perspective view of the gas cylinder valve shown in FIGS. 1 and 2.

Apart from the provision of the permanent coating of solid (or “dry”) lubricant, those skilled in the art will readily appreciate that the gas cylinder valve shown in the drawings is of a known, commercially available, kind and it is therefore unnecessary for an understanding of the invention to describe the configuration and operation of the valve in detail.

The gas cylinder valve shown in the drawings has a body 2, typically formed of brass. The body 2 is adapted to engage and be held tight by the mouth of a gas cylinder not shown. The configuration of the outer surface of the lower end of the body 2 is therefore chosen to be complementary with that of the inner surface of the mouth of the gas cylinder.

The valve body 2 has a main bore 4 formed therethrough from top to bottom as shown. The bore 4 is generally wider at its top than its bottom so as to accommodate a gland nut 6 which engages the body 2. An upper or outer spindle 10 extends downwardly through the gland nut 6. The top or outer end of the upper spindle 10 carries a handwheel 8. Rotation of the handwheel causes frictional contact of the upper spindle 10 and the gland nut 6. The frictional surfaces of these parts (i.e. the surfaces that rub together when the spindle 10 is translated) both have a uniform permanent coating typically from 0.5 to 1 micron thick of tungsten disulfide.

The lower or inner end of the upper spindle 10 engages a lower or outer spindle 12. The bottom or inner end of the lower spindle 12 carries a packing 14 that acts as the valve closing member which when the valve is closed engages a valve seat 16 formed in and integral with the body 2. Rotation of the handwheel 8 causes frictional contact of the lower spindle 12 against a part of the wall of the bore, and either one or both of these frictional surfaces both have a permanent coating of tungsten disulfide, the or each coating typically having a uniform thickness in the range of 0.5 to 1 micron.

The main bore 4 of the cylinder valve 2 communicates with a side bore that houses the residual pressure valve 20. The residual pressure valve 20 has a spring loaded shuttle 22. This shuttle 22 is able to be displaced relative to a back nut 24. The contacting surfaces of the shuttle 22 and the back nut 24 both have a permanent coating of tungsten disulfide, each coating typically having a uniform thickness in the range of 0.5 to 1 micron.

In view of the provision of the aforementioned surfaces having a coating of tungsten disulfide, the valve shown in the drawings has no grease or lubricant oil whatsoever. The disadvantages associated with the user of such grease or oil are therefore avoided.

1. A gas cylinder valve having a permanent coating of a solid lubricant on at least one of its internal frictional surfaces wherein the solid lubricant consists of or comprises tungsten disulfide.

2. A gas cylinder valve according to claim 1, wherein the gas cylinder valve incorporates a residual pressure valve, pressure regulating valve or a flow control valve, or incorporates none of these.

3. A gas cylinder valve according to claim 1 wherein the permanent coating of solid lubricant has a uniform thickness of up to 5 microns.

4. A gas cylinder valve according to claim 3, wherein the thickness is in the range of 0.5 to 1 micron.

5. A gas cylinder valve according to claim 1, wherein gas cylinder valve has a spindle having a frictional surface which bears said permanent coating of solid lubricant.

6. A gas cylinder valve according to claim 5, wherein the valve spindle has an upper part and a lower part, and both parts bear a permanent coating of solid lubricant.

7. A gas cylinder valve according to claim 5, wherein the complementary surface or surfaces of the valve to the coated surfaces of the spindle also bear a permanent coating of the solid lubricant.
